(19) United States
(12) Patent Application Publication
(10) Pub. No.: US 2023/0405695 A1
(43) Pub. Date: Dec. 21, 2023

(54) ABRASIVE BELT CLAMP HOLDER USED WITH SCROLL SAW AND USING METHOD

(71) Applicant: WEIHAI ALLWIN ELECTRICAL AND MECHANICAL TECH.CO.,LTD, Weihai (CN)

(72) Inventors: Fei YU, Weihai (CN); Xuguang JING, Weihai (CN); Liyi SUN, Weihai (CN); Huili YANG, Weihai (CN); Jian SUN, Weihai (CN); Jingde WANG, Weihai (CN); Jialing LIU, Weihai (CN)

(21) Appl. No.: 18/456,873

(22) Filed: Aug. 28, 2023

Related U.S. Application Data
(63) Continuation-in-part of application No. PCT/CN2022/098599, filed on Jun. 14, 2022.

(30) Foreign Application Priority Data
Jun. 16, 2021 (CN) 202110666709.5

(51) Int. Cl. B23D 59/00; B24B 55/08; B24B 41/047

(52) U.S. Cl. CPC B23D 59/006; B24B 55/08; B24B 41/0475

(57) ABSTRACT

The invention discloses an abrasive belt clamp holder used with scroll saw and using method, and belongs to the technical field of scroll saws. An abrasive belt clamp holder used with scroll saw comprising a pin-free saw blade, wherein a clamp holder main body is connected to each of two ends of the pin-free saw blade, a placement groove matching the pin-free saw blade is provided in an outer wall of the clamp holder main body, a first bolt is movably connected to each of two sides of the outer wall of the clamp holder main body, the pin-free saw blade is disposed between two first bolts, a clamping plate is detachably connected to the top of the clamp holder main body, and an abrasive belt is connected between the clamping plate and the clamp holder main body.

### CROSS-REFERENCE TO RELATED APPLICATIONS

This application is a continuation-in-part application of PCT Patent Application No. PCT/CN2022/098599, filed on Jun. 14, 2022, which claims priority to Chinese patent application No. 202110666709.5, filed on Jun. 16, 2021, the entirety of all of which is incorporated herein by their reference.

### TECHNICAL FIELD

The invention relates to the technical field of scroll saws, particularly to an abrasive belt clamp holder used with scroll saw and using method.

### BACKGROUND

Scroll saws are one of the common power tools for cutting. The existing scroll saws are generally mechanically automated and work on the following principle: the motor decelerates through the gears and the eccentric roller sleeve on the large gear drives the reciprocating lever and saw blade in a reciprocating motion for cutting, the teeth are relatively large and efficient when cutting wood and other wood products, the teeth are sharpened and tapered, cutting quickly and with greater chip handling capacity.

When pin-free saw blades are used, most of the scroll saws use different forms of clamp holders to clamp them. Currently on the market are single-function clamp holders that can only clamp pin-free saw blades, while a workpiece, though cut by the scroll saw, still need to be ground using an abrasive belt, resulting in the necessity to replace the workpiece, thus extending the time to machine the workpiece. When cutting and grinding workpieces, generally electric jigsaws are also dragsaws. As the saw is pulled up and down, sawdust builds up on the sawpath and requires the operator to keep blowing to remove the sawdust to see the path. Although some designs have air blowing ports to blow off the sawdust from the sawpath so that the user can see the scribing line, the sawdust is blown away and easily absorbed by the human body, endangering human health, and not easy to clean up, increasing the labor intensity of the worker.

### SUMMARY

The purpose according to various embodiments of the present disclosure is to solve the problems existing in the prior art and to propose an abrasive belt clamp holder used with scroll saw and using method.

In order to achieve the above, the present disclosure employs the following technical scheme:

An abrasive belt clamp holder used with scroll saw comprises a pin-free saw blade, wherein a clamp holder main body is connected to each of two ends of the pin-free saw blade, a placement groove matching the pin-free saw blade is provided in an outer wall of the clamp holder main body, a first bolt is movably connected to each of two sides of the outer wall of the clamp holder main body, the pin-free saw blade is disposed between two first bolts, a clamping plate is detachably connected to the top of the clamp holder main body, an abrasive belt is connected between the clamping plate and the clamp holder main body, a second bolt is movably connected between the clamping plate and the clamp holder main body, a working housing is connected to the clamp holder main body, a driving mechanism is provided in the working housing, a transmission mechanism is provided on an outer wall of the working housing, a collecting housing is connected to the bottom of the working housing, an air draft assembly is provided in the collecting housing and the driving mechanism drives the air draft assembly to work by means of the transmission mechanism.

Preferably, the driving mechanism comprises a rack and a moving gear, the rack and the moving gear are intermeshed, the rack is slidingly connected in the working housing, the moving gear is rotatably connected in the working housing by means of a rotating shaft, a base plate is connected to a bottom wall of the rack, an elastic telescopic rod is connected between a top wall of the base plate and a bottom wall of the working housing, a rotating rod is rotatably connected to an inner wall of the working housing, matching synchronizing wheels are connected to the rotating rod and an outer wall of the rotating shaft, and a belt is connected between these two synchronizing wheels.

Preferably, the driving mechanism comprises an ear plate, the ear plate is connected to the outer wall of the working housing, a rotating shaft is rotatably connected in the ear plate, a driven bevel gear is connected to the top of the rotating shaft, and a driving bevel gear, which is intermeshed with the driven bevel gear, is connected to the outer wall of the rotating rod.

Preferably, the rotating shaft passes through the collecting housing at one end away from the driven bevel gear and is connected to the air draft assembly, and the air draft assembly is provided in the form of a fan blade of a non-fully antisymmetric shape.

Preferably, an arc-shaped screen is connected to the inner wall of the collecting housing, the arc-shaped screen is disposed below the air draft assembly, a flow guide is also provided on the inner wall of the collecting housing, and a baffle is provided at the end of the flow guide.

Preferably, the bottom of the collecting housing is provided with an opening with a narrow top and a wide bottom.

Preferably, the elastic telescopic rod comprises an outer tube, an inner tube and an elastic element, the outer tube is connected to the base plate, the inner tube is connected to the bottom wall of the working housing, the inner tube is slidingly connected in the outer tube, a fixed rod is connected to an inner wall of the outer tube, a piston is connected to one end of the fixed rod away from the inner wall of the outer tube, and the outer diameter of the piston is the same as the inner diameter of the inner tube.

Preferably, a branch air tube is connected to the outer wall of the inner tube, a main air tube is connected to one end of the branch air tube away from the inner tube, the main air tube passes through the collecting housing and is connected with an air cylinder, the air cylinder is connected to the outer wall of the arc-shaped screen and outlet holes are evenly distributed on the outer wall of the air cylinder.

Preferably, evenly distributed balls are provided on the outer wall of the base plate.

The invention also discloses a use method of an abrasive belt clamp holder used with scroll saw, comprising the steps of:

S1: to use the clamp holder, the pin-free saw blade is disposed in the placement groove, the two ends of the pin-free saw blade are clamped and secured by means of the first bolts at both sides of the clamp holder main body then the clamping plate and the clamp holder main body are secured by means of second bolts, so that the abrasive belt is clamped by the clamping plate and the clamp holder main body, and the frosted finish of the abrasive belt is placed against the back of the serrated face of the pin-free saw blade, so that the function of clamping the abrasive belt is added for the clamp holder main body on the basis of clamping the pin-free saw blade, the scroll saw can cut by means of the saw blade, and can also grind a cut workpiece more easily by means of the abrasive belt, without the need to change the machining tool, thereby shortening the machining time of the workpiece;

S2: to use the pin-free saw blade for machining, the base plate at the bottom of the rack is placed against the outer wall of the workpiece, and in the process of the pin-free saw blade moving up and down reciprocally on the outside of the workpiece to drag and cut, the clamp holder main body drives the working housing connected to it on the outside to move up and down, causing the moving gear inside the working housing to move with it, causing the moving gear to engage with the rack in the process of moving, the moving gear to rotate inside the working housing by means of the rotating shaft, and the rotating rod to move with the rotating shaft under the action of the synchronizing wheel and the belt; the driving bevel gear on the outside of the rotating rod is intermeshed with the driven bevel gear on the outside of the rotating shaft, so that the rotating shaft drives the air draft assembly to rotate inside the collecting housing, so that the sawdust is collected inside the collecting housing to prevent from scattering all around, to facilitate clean-up, and a good machining environment is conveniently provided, thereby reducing the labor intensity of staff;

S3: when the air draft assembly is used for sawdust extraction, the sawdust falls onto the arc-shaped screen with the flow guide and moves along the cambered surface of the arc-shaped screen from the middle to both sides, and when the moving gear engages with the rack in reverse, the sawdust attached to both sides of the arc-shaped screen is no longer subject to suction and falls into the chambers at both sides of the collecting housing, and the baffle prevents the sawdust from splashing again;

S4: the elastic telescopic rod intermittently contracts as the working housing moves up and down, and in the process of contraction, the inner tube slides downwards in the outer tube, and the piston squeezes the air in the inner tube so that the air in the inner tube enters into the air cylinder through the branch air tube and the main air tube, causing the air to be discharged from the outlet holes, blowing on the sawdust attached to the arc-shaped screen for further treatment, so that the sawdust moves further to both sides of the arc-shaped screen and thus into the chambers at two sides of the collecting housing.

Compared to the prior art, the present disclosure provides an abrasive belt clamp holder used with scroll saw and using method, with the following beneficial effects:

1. This multi-purpose clamp holder for a scroll saw and using method has the function of clamping the abrasive belt added on the basis of clamping the pin-free saw blade, so that the scroll saw can cut by means of the saw blade, and can also grind a cut workpiece more easily by means of the abrasive belt to shorten the machining time of the workpiece; and in the process of grinding and cutting the workpiece, sawdust and dust are extracted by means of a collecting housing to prevent sawdust from scattering all around, to facilitate clean-up, and a good machining environment is conveniently provided, thereby reducing the labor intensity of staff.

2. This multi-purpose clamp holder for a scroll saw and using method moves up and down with the pin-free saw blade through the working housing, causing the moving gear inside the working housing to move with it, causing the moving gear to engage with the rack in the process of moving, the moving gear to rotate inside the working housing by means of the rotating shaft, and the rotating rod to move with the rotating shaft under the action of the synchronizing wheel and the belt; the driving bevel gear on the outside of the rotating rod is intermeshed with the driven bevel gear on the outside of the rotating shaft, so that the rotating shaft drives the air draft assembly to rotate inside the collecting housing, so that the sawdust is collected inside the collecting housing to prevent from scattering all around, to facilitate clean-up, and a good machining environment is conveniently provided, thereby reducing the labor intensity of staff; the air draft assembly only relies on the pin-free saw blade to provide power in the up-and-down sawing process, which is simple and convenient and does not require an additional power source such as an electric motor, reducing machining costs and increasing practicality.

3. This multi-purpose clamp holder for a scroll saw and using method has the elastic telescopic rod intermittently contracting as the working housing moves up and down, and in the process of contraction, the inner tube slides downwards in the outer tube, and the piston squeezes the air in the inner tube so that the air in the inner tube enters into the air cylinder through the branch air tube and the main air tube, causing the air to be discharged from the outlet holes, blowing on the sawdust attached to the arc-shaped screen for further treatment, so that the sawdust moves further to both sides of the arc-shaped screen and thus into the chambers at two sides of the collecting housing.

4. This multi-purpose clamp holder for a scroll saw and using method has the air draft assembly provided in the form of a fan blade of a non-fully antisymmetric shape, so that when the moving gear is turning forward the fan blade only air suction draws air from below, the amount of air blowing above is very small, such that when the blade is turned in reverse it makes no air blowing below the fan blade, avoiding that when the moving gear is turned back and forth the fan blade is reversed and blows the sawdust out of the collecting housing, ensuring the efficiency of sawdust collection.

5. This multi-purpose clamp holder for a scroll saw and using method increases the collection range of the collecting housing and improves the capacity of sawdust collection by providing the bottom of the collecting housing with a narrow top and a wide bottom opening.

### BRIEF DESCRIPTION OF THE DRAWINGS

FIG. 1 is a schematic view showing the structure according to various embodiments of the present disclosure;

FIG. 2 is a schematic view showing the structure of portion A in FIG. 1 according to various embodiments of the present disclosure;

FIG. 3 is an exploded view showing the structure of the clamp holder main body and the pin-free saw blade according to various embodiments of the present disclosure;

FIG. 4 is a schematic view (1) showing the structure of the working housing and the collecting housing according to various embodiments of the present disclosure;

FIG. 5 is a schematic view (2) showing the structure of the working housing and the collecting housing according to various embodiments of the present disclosure;

FIG. 6 is a schematic view showing the structure of the working housing according to various embodiments of the present disclosure;

FIG. 7 is a schematic view showing the structure of the telescopic rod according to various embodiments of the present disclosure;

FIG. 8 is a sectional view showing the structure of the collecting housing according to various embodiments of the present disclosure;

FIG. 9 is a schematic view showing the structure of the air cylinder according to various embodiments of the present disclosure;

FIG. 10 is a schematic view showing the structure of the collecting housing according to various embodiments of the present disclosure; and

FIG. 11 is a schematic view showing the overall appearance of the abrasive belt clamp holder according to various embodiments of the present disclosure.

Reference numbers in the figures: 1. Pin-free saw blade; 2. Clamp holder main body; 201. Placement groove; 202. First bolt; 3. Clamping plate; 301. Second bolt; 4. Abrasive belt; 5. Working housing; 501. Rack; 5011. Base plate; 502. Moving gear; 503. Rotating rod; 5031. Synchronizing wheel; 5032. Driving bevel gear; 6. Collecting housing; 601. Arc-shaped screen; 602. Flow guide; 6021. Baffle; 7. Ear plate; 701. Rotating shaft; 7011. Driven bevel gear; 8. Air draft assembly; 9. Elastic telescopic rod; 901. Outer tube; 9011. Fixed rod; 9012. Piston; 902. Inner tube; 903. Elastic element; 10. Ball; 11. Branch air tube; 111. Main air tube; 12. Air cylinder; 121. Outlet hole.

### DETAILED DESCRIPTION

The technical scheme in the embodiment of the present disclosure will be described clearly and completely below with reference to the drawings in the embodiment of the present disclosure. Obviously, the described embodiment is only a part of the embodiment of the present disclosure, not all of the embodiment.

In the description of the present disclosure, it should be understood that, the orientation or positional relationship indicated by the terms “upper”, “lower”, “front”, “back”, “left”, “right”, “top”, “bottom”, “inner”, “outer”, etc., is based on the orientation or positional relationship shown in the figures, is merely for the convenience of describing the present disclosure and the simplified description, and is not intended to indicate or imply that the indicated device or element must have a particular orientation, constructed and operated in a particular orientation, and therefore not to be construed as a limitation of the present disclosure.

Referring to FIGS. 11, is the overall appearance of the abrasive belt clamp holder used with scroll saw, used to show the overall structure of the scroll saw.

### EMBODIMENT 1

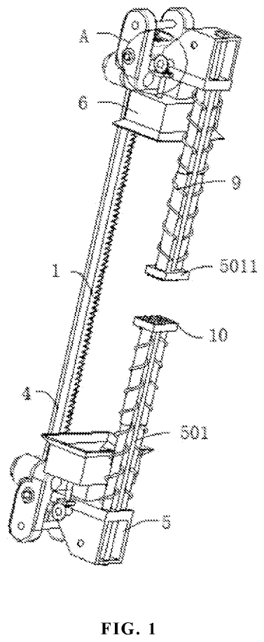

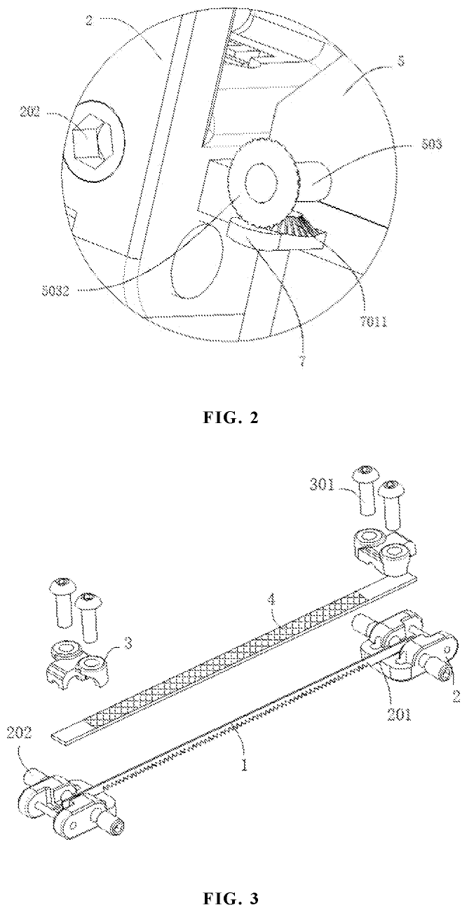

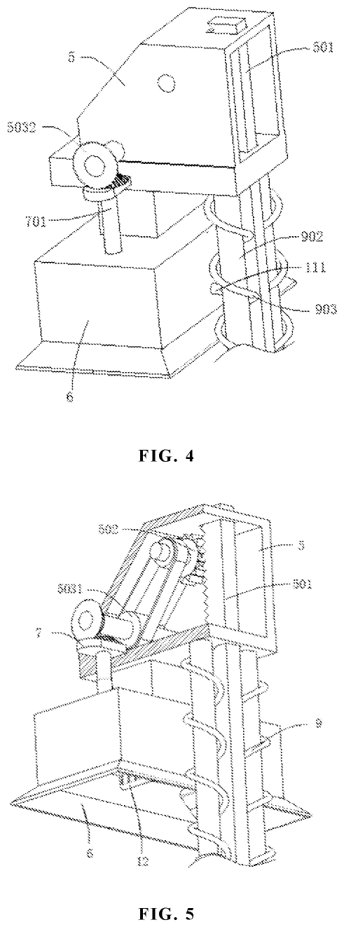

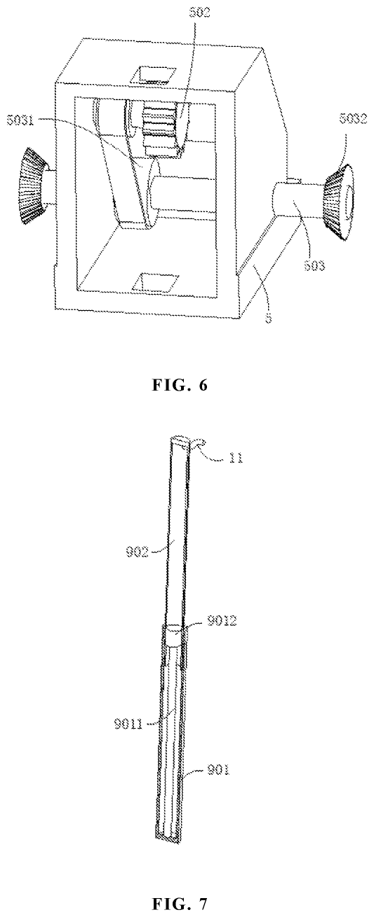

Referring to FIGS. 1 through 8, an abrasive belt clamp holder used with scroll saw, comprises a pin-free saw blade 1, wherein a clamp holder main body 2 is connected to each of two ends of the pin-free saw blade 1, a placement groove 201 matching the pin-free saw blade 1 is provided in an outer wall of the clamp holder main body 2, a first bolt 202 is movably connected to each of two sides of the outer wall of the clamp holder main body 2, the pin-free saw blade 1 is disposed between two first bolts 202, a clamping plate 3 is detachably connected to the top of the clamp holder main body 2, an abrasive belt 4 is connected between the clamping plate 3 and the clamp holder main body 2, a second bolt 301 is movably connected between the clamping plate 3 and the clamp holder main body 2, a working housing 5 is connected to the clamp holder main body 2, a driving mechanism is provided in the working housing 5, a transmission mechanism is provided on an outer wall of the working housing 5, a collecting housing 6 is connected to the bottom of the working housing 5, an air draft assembly 8 is provided in the collecting housing 6 and the driving mechanism drives the air draft assembly 8 to work by means of the transmission mechanism.

The driving mechanism comprises a rack 501 and a moving gear 502, the rack 501 and the moving gear 502 are intermeshed, the rack 501 is slidingly connected in the working housing 5, the moving gear 502 is rotatably connected in the working housing 5 by means of a rotating shaft, a base plate 5011 is connected to a bottom wall of the rack 501, an elastic telescopic rod 9 is connected between a top wall of the base plate 5011 and a bottom wall of the working housing 5, a rotating rod 503 is rotatably connected to an inner wall of the working housing 5, matching synchronizing wheels 5031 are connected to the rotating rod 503 and an outer wall of the rotating shaft, and a belt is connected between these two synchronizing wheels 5031.

The driving mechanism comprises an ear plate 7, the ear plate 7 is connected to the outer wall of the working housing 5, a rotating shaft 701 is rotatably connected in the ear plate 7, a driven bevel gear 7011 is connected to the top of the rotating shaft 701, and a driving bevel gear 5032, which is intermeshed with the driven bevel gear 7011, is connected to the outer wall of the rotating rod 503.

The rotating shaft 701 passes through the collecting housing 6 at one end away from the driven bevel gear 7011 and is connected to the air draft assembly 8, and the air draft assembly 8 is provided in the form of a fan blade of a non-fully antisymmetric shape.

To use the clamp holder, the pin-free saw blade 1 is disposed in the placement groove 201, the two ends of the pin-free saw blade 1 are clamped and secured by means of the first bolts 202 at both sides of the clamp holder main body 2, then the clamping plate 3 and the clamp holder main body 2 are secured by means of second bolts 301, so that the abrasive belt 4 is clamped by the clamping plate 3 and the clamp holder main body 2, and the frosted finish of the abrasive belt 4 is placed against the back of the serrated face of the pin-free saw blade 1, so that the function of clamping the abrasive belt 4 is added for the clamp holder main body 2 on the basis of clamping the pin-free saw blade 1, the scroll saw can cut by means of the saw blade, and can also grind a cut workpiece more easily by means of the abrasive belt 4, without the need to change the machining tool, thereby shortening the machining time of the workpiece; to use the pin-free saw blade 1 for machining, the base plate 5011 at the bottom of the rack 501 is placed against the outer wall of the workpiece, and in the process of the pin-free saw blade 1 moving up and down reciprocally on the outside of the workpiece to drag and cut, the clamp holder main body 2 drives the working housing 5 connected to it on the outside to move up and down, causing the moving gear 502 inside the working housing 5 to move with it, causing the moving gear 502 to engage with the rack 501 in the process of moving, the moving gear 502 to rotate inside the working housing 5 by means of the rotating shaft, and the rotating rod 503 to move with the rotating shaft under the action of the synchronizing wheel 5031 and the belt; the driving bevel gear 5032 on the outside of the rotating rod 503 is intermeshed with the driven bevel gear 7011 on the outside of the rotating shaft 701, so that the rotating shaft 701 drives the air draft assembly 8 to rotate inside the collecting housing 6, so that the sawdust is collected inside the collecting housing 6 to prevent from scattering all around, to facilitate clean-up, and a good machining environment is conveniently provided, thereby reducing the labor intensity of staff

### EMBODIMENT 2

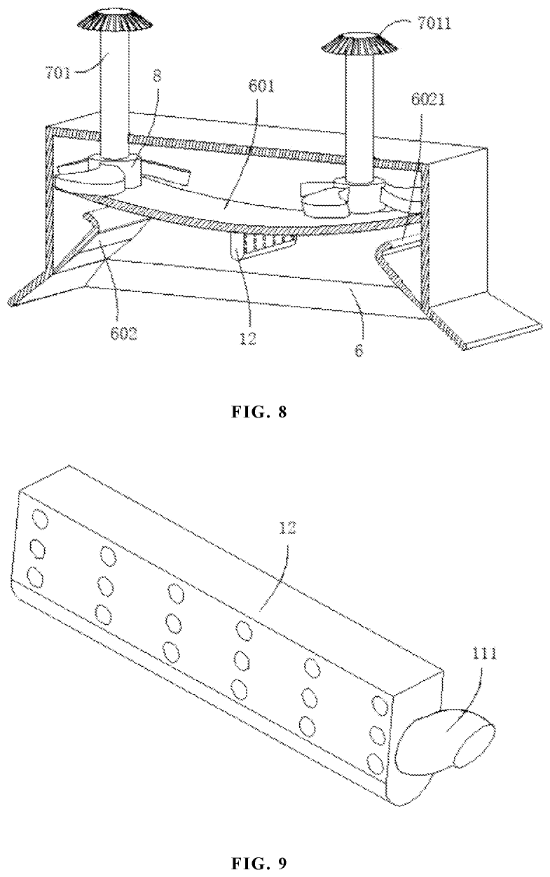

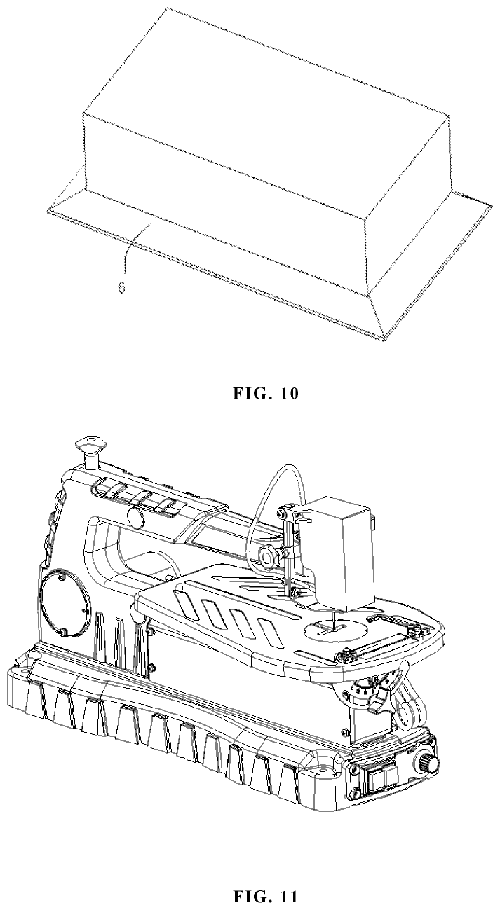

Referring to FIG. 8, an abrasive belt clamp holder used with scroll saw is essentially the same as in Embodiment 1, furthermore, an arc-shaped screen 601 is connected to the inner wall of the collecting housing 6, the arc-shaped screen 601 is disposed below the air draft assembly 8, a flow guide 602 is also provided on the inner wall of the collecting housing 6, and a baffle 6021 is provided at the end of the flow guide 602.

When the air draft assembly 8 is used for sawdust extraction, the sawdust falls onto the arc-shaped screen 601 with the flow guide 602 and moves along the cambered surface of the arc-shaped screen 601 from the middle to both sides, and when the moving gear 502 engages with the rack 501 in reverse, the sawdust attached to both sides of the arc-shaped screen 601 falls into the chambers at both sides of the collecting housing 6, and the baffle 6021 prevents the sawdust from splashing again.

### EMBODIMENT 3

Referring to FIGS. 5, 7, 8 and 9, an abrasive belt clamp holder used with scroll saw is essentially the same as in Embodiment 1, furthermore, the elastic telescopic rod 9 comprises an outer tube 901, an inner tube 902 and an elastic element 903, the outer tube 901 is connected to the base plate 5011, the inner tube 902 is connected to the bottom wall of the working housing the inner tube 902 is slidingly connected in the outer tube 901, a fixed rod 9011 is connected to an inner wall of the outer tube 901, a piston 9012 is connected to one end of the fixed rod 9011 away from the inner wall of the outer tube 901, and the outer diameter of the piston 9012 is the same as the inner diameter of the inner tube 902.

A branch air tube 11 is connected to the outer wall of the inner tube 902, a main air tube 111 is connected to one end of the branch air tube 11 away from the inner tube 902, the main air tube 111 passes through the collecting housing 6 and is connected with an air cylinder 12, the air cylinder 12 is connected to the outer wall of the arc-shaped screen 601 and outlet holes 121 are evenly distributed on the outer wall of the air cylinder 12.

The elastic telescopic rod 9 intermittently contracts as the working housing 5 moves up and down, and in the process of contraction, the inner tube 902 slides downwards in the outer tube 901, and the piston 9012 squeezes the air in the inner tube 902 so that the air in the inner tube 902 at both sides combines and enters into the main air tube 111 via the branch air tube 11, and enters into the air cylinder 12 through the main air tube 111, causing the air to be discharged from the outlet holes 121, blowing on the sawdust attached to the arc-shaped screen 601 for further treatment, so that the sawdust moves further to both sides of the arc-shaped screen 601 and thus into the chambers at two sides of the collecting housing 6.

### EMBODIMENT 4

Referring to FIGS. 1 and 11, an abrasive belt clamp holder used with scroll saw is essentially the same as in Embodiment 1, furthermore, the bottom of the collecting housing 6 is provided with an opening with a narrow top and a wide bottom, to increase the collection range of the collecting housing 6 and improve the capacity of sawdust collection.

Evenly distributed balls 10 are provided on the outer wall of the base plate 5011, so that the base plate 5011 can be moved during the moving and cutting of the workpiece by the pin-free saw blade 1, avoiding sawing interruptions and affecting the sawing effect.

The above is only a preferred specific embodiment of the present disclosure, but the scope of protection of the present disclosure is not limited thereto, and any equivalent substitution or change made by any person skilled in the art in accordance with the technical scheme of the present disclosure and its inventive concept within the technical scope disclosed herein shall be covered by the scope of protection of the present disclosure.

What is claimed is:

1. An abrasive belt clamp holder used with scroll saw, comprising a pin-free saw blade, wherein a clamp holder main body is connected to each of two ends of the pin-free saw blade, a placement groove matching the pin-free saw blade is provided in an outer wall of the clamp holder main body, a first bolt is movably connected to each of two sides of the outer wall of the clamp holder main body, the pin-free saw blade is disposed between two first bolts, a clamping plate is detachably connected to the top of the clamp holder main body, an abrasive belt is connected between the clamping plate and the clamp holder main body, a second bolt is movably connected between the clamping plate and the clamp holder main body.

2. The abrasive belt clamp holder used with scroll saw according to claim 1, wherein, a working housing is connected to the outer wall of the clamp holder main body, a driving mechanism is provided in the working housing, a transmission mechanism is provided on an outer wall of the working housing, a collecting housing is connected to the bottom of the working housing, an air draft assembly is provided in the collecting housing, and the driving mechanism drives the air draft assembly to work by means of the transmission mechanism; the driving mechanism comprises a rack and a moving gear, the rack and the moving gear are intermeshed, the rack is slidingly connected in the working housing, the moving gear is rotatably connected in the working housing by means of a rotating shaft, a base plate is connected to a bottom wall of the rack, an elastic telescopic rod is connected between a top wall of the base plate and a bottom wall of the working housing, a rotating rod is rotatably connected to an inner wall of the working housing, matching synchronizing wheels are connected to the rotating rod and an outer wall of the rotating shaft, and a belt is connected between these two synchronizing wheels.

3. The abrasive belt clamp holder used with scroll saw according to claim 2, wherein, the driving mechanism comprises an ear plate, the ear plate is connected to the outer wall of the working housing, a rotating shaft is rotatably connected in the ear plate, a driven bevel gear is connected to the top of the rotating shaft, and a driving bevel gear, which is intermeshed with the driven bevel gear, is connected to the outer wall of the rotating rod.

4. The abrasive belt clamp holder used with scroll saw according to claim 3, wherein, the rotating shaft passes through the collecting housing at one end away from the driven bevel gear and is connected to the air draft assembly, and the air draft assembly is provided in the form of a fan blade of a non-fully antisymmetric shape.

5. The abrasive belt clamp holder used with scroll saw according to claim 4, wherein, an arc-shaped screen is connected to the inner wall of the collecting housing, the arc-shaped screen is disposed below the air draft assembly, a flow guide is also provided on the inner wall of the collecting housing, and a baffle is provided at the end of the flow guide.

6. The abrasive belt clamp holder used with scroll saw according to claim 5, wherein, the bottom of the collecting housing is provided with an opening with a narrow top and a wide bottom.

7. The abrasive belt clamp holder used with scroll saw according to claim 2, wherein, the elastic telescopic rod comprises an outer tube, an inner tube and an elastic element, the outer tube is connected to the base plate, the inner tube is connected to the bottom wall of the working housing the inner tube is slidingly connected in the outer tube, a fixed rod is connected to an inner wall of the outer tube, a piston is connected to one end of the fixed rod away from the inner wall of the outer tube, and the outer diameter of the piston is the same as the inner diameter of the inner tube.

8. The abrasive belt clamp holder used with scroll saw according to claim 7, wherein, a branch air tube is connected to the outer wall of the inner tube, a main air tube is connected to one end of the branch air tube away from the inner tube, the main air tube passes through the collecting housing and is connected with an air cylinder, the air cylinder is connected to the outer wall of the arc-shaped screen and outlet holes are evenly distributed on the outer wall of the air cylinder.

9. The abrasive belt clamp holder used with scroll saw according to claim 7, wherein, evenly distributed balls are provided on the outer wall of the base plate.

10. A method of using the abrasive belt clamp holder with scroll saw according to claim 1, the method comprising:
S1: to use the clamp holder, the pin-free saw blade is disposed in the placement groove, the two ends of the pin-free saw blade are clamped and secured by means of the first bolts at both sides of the clamp holder main body, then the clamping plate and the clamp holder main body are secured by means of second bolts, so that the abrasive belt is clamped by the clamping plate and the clamp holder main body, and the frosted finish of the abrasive belt is placed against the back of the serrated face of the pin-free saw blade, so that the function of clamping the abrasive belt is added for the clamp holder main body on the basis of clamping the pin-free saw blade, the scroll saw can cut by means of the saw blade, and can also grind a cut workpiece more easily by means of the abrasive belt, and has two functions of cutting and grinding, without the need to change the machining tool, thereby shortening the machining time of the workpiece;
S2: to use the pin-free saw blade for machining, the base plate at the bottom of the rack is placed against the outer wall of the workpiece, and in the process of the pin-free saw blade moving up and down reciprocally on the outside of the workpiece to drag and cut, the clamp holder main body drives the working housing connected to it on the outside to move up and down, causing the moving gear inside the working housing to move with it, causing the moving gear to engage with the rack in the process of moving, the moving gear to rotate inside the working housing by means of the rotating shaft, and the rotating rod to move with the rotating shaft under the action of the synchronizing wheel and the belt; the driving bevel gear on the outside of the rotating rod is intermeshed with the driven bevel gear on the outside of the rotating shaft, so that the rotating shaft drives the air draft assembly to rotate inside the collecting housing, so that the sawdust is collected inside the collecting housing to prevent from scattering all around, to facilitate clean-up, and a good machining environment is conveniently provided, thereby reducing the labor intensity of staff;
S3: when the air draft assembly is used for sawdust extraction, the sawdust falls onto the arc-shaped screen with the flow guide and moves along the cambered surface of the arc-shaped screen from the middle to both sides, and when the moving gear engages with the rack in reverse, the sawdust attached to both sides of the arc-shaped screen is no longer subject to suction and falls into the chambers at both sides of the collecting housing, and the baffle prevents the sawdust from splashing again;
S4: the elastic telescopic rod intermittently contracts as the working housing moves up and down, and in the process of contraction, the inner tube slides downwards in the outer tube, and the piston squeezes the air in the inner tube so that the air in the inner tube enters into the air cylinder through the branch air tube and the main air tube, causing the air to be discharged from the outlet holes, blowing on the sawdust attached to the arc-shaped screen for further treatment, so that the sawdust moves further to both sides of the arc-shaped screen and thus into the chambers at two sides of the collecting housing.
